(19) United States
(12) Patent Application Publication
(10) Pub. No.: US 2026/0292958 A1
(43) Pub. Date: Sep. 24, 2026

(54) METHOD AND SYSTEM FOR REAL-TIME CONTROL OF SPECTRALLY TUNABLE LIGHT SOURCES USING PRE-COMPUTED SIMPLEX MESHES

(71) Applicant: Carter Peterson, Brooklyn, NY (US)

(72) Inventor: Carter Peterson, Brooklyn, NY (US)

(21) Appl. No.: 19/574,167

(22) Filed: Mar. 20, 2026

Related U.S. Application Data
(60) Provisional application No. 63/775,907, filed on Mar. 21, 2025.

(51) Int. Cl. H05B 47/165; H05B 45/12; H05B 45/22; H05B 47/11; H05B 47/115; H05B 47/155; H05B 47/175

(52) U.S. Cl. CPC H05B 47/165; H05B 45/12; H05B 45/22; H05B 47/11; H05B 47/115; H05B 47/155; H05B 47/1965

(57) ABSTRACT

A system and method for controlling spectrally tunable light sources that enables real-time adjustment of spectral power distributions through the use of pre-computed simplex meshes. The invention dramatically reduces computational complexity compared to traditional optimization methods by subdividing the coordinate space into n-dimensional simplexes, pre-computing optimal spectral mixes at all simplex vertices and using barycentric coordinate interpolation for real-time mix generation. The system supports arbitrary optimization targets and can operate in n-dimensional space to simultaneously control multiple spectral characteristics.

### CROSS-REFERENCE TO RELATED APPLICATION

This application claims the benefit of U.S. Provisional Patent Application No. 63/775,907, filed Mar. 21, 2025, which is incorporated by reference herein in its entirety.

### BACKGROUND

### Field

The present invention relates to the field of lighting control systems, specifically to systems and methods for controlling spectrally tunable light sources in real-time applications.

### Background

Spectrally tunable lighting systems combine multiple light-emitting elements of different wavelengths to produce desired spectral power distributions. These systems, however, have typically required significant computing resources in processing resources and time. As system complexity and features of these lighting systems grow, so too does the demand for the computational resources, including processing cycles and energy usage. Conventional approaches to lighting control often come at the expense of such computational efficiency.

Modern environments are increasingly resource-constrained with needs for improved energy and computational efficiency. The availability and cost profile of computational resources are undergoing significant shifts. Supply chain volatility, increased demand for high-performance computing components, and the growing integration of computation across a various devices have contributed to rising costs for processing hardware. Additionally, rising power and thermal costs have impacted many deployment scenarios.

Accordingly, there is a need for improved control of spectrally tunable lighting systems that reduce computational requirements while maintaining feature-rich systems. Such improvements would enable more efficient use of hardware resources and expand the feasibility of deploying advanced lighting capabilities in a broad range of applications.

### SUMMARY

In an aspect of the disclosure, a spectrally tunable lighting system is disclosed. The lighting system may include a set of spectrally tunable light elements, each of the set of light elements having a spectral response curve defined by an intensity coefficient and frequency response. The lighting system may include a memory for storing pre-computed intensity coefficients for each of the set of spectrally tunable light elements, where the pre-computed intensity coefficients are determined prior to a runtime of the spectrally tunable lighting system, and where the pre-computed intensity coefficients correspond to vertices of a simplex mesh of the spectral response curve. The lighting system may include the memory further storing instructions for controlling the spectrally tunable lighting system based on the stored pre-computed intensity coefficients. The lighting system may include a processor configured for executing the instructions of the memory.

In another aspect of the disclosure, method for a spectrally tunable lighting system is disclosed. The method may include retrieving, at a memory of the spectrally tunable lighting system, a set of pre-computed intensity coefficients for a set of spectrally tunable lighting elements of the system, each of the set of light elements having a spectral response curve defined by an intensity coefficient and frequency response, and the pre-computed intensity coefficients determined prior to a runtime of the lighting system, where the pre-computed intensity coefficients correspond to vertices of a simplex mesh of the spectral response curve. The method may include powering the set of lighting elements based on the pre-computed intensity coefficients.

### BRIEF DESCRIPTION OF THE DRAWINGS

FIG. 1 is a block diagram illustrating a system architecture for generating and utilizing pre-computed spectral mixes in a tunable light source.

FIG. 2 is a block diagram illustrating a cloud-based and network-connected architecture for preprocessing and multi-device coordination.

FIG. 3 is a diagram showing an initial control space with achievable boundaries and light source locations.

FIG. 4 is a diagram illustrating the overlay of a regular grid structure onto the control space.

FIG. 5 is a diagram showing the final simplex mesh with interior and boundary simplex subdivision.

FIG. 6 is a diagram illustrating adaptive mesh refinement with varying simplex density across regions of the control space.

FIG. 7 is a block diagram illustrating machine learning enhanced mesh generation during the preprocessing phase.

FIG. 8 is a diagram showing a spectral mix generated for a simplex mesh vertex via optimization.

FIG. 9 is a flowchart illustrating the runtime process for converting target coordinates into final spectral mixes.

FIG. 10 is a block diagram illustrating sensor feedback loops for adaptive control and compensation during runtime operation.

FIG. 11 is a diagram illustrating the calculation of barycentric coordinates for a target point within a single simplex of the mesh.

FIG. 12A and FIG. 12B are diagrams illustrating the dimensional flexibility of the approach.

FIG. 13 is a diagram illustrating circadian rhythm control with target coordinate trajectories over a 24-hour period through a multi-dimensional control space.

FIG. 14A and FIG. 14B are diagrams illustrating a dual PCB electrical implementation of the spectrally tunable light source system.

FIG. 15 is a block diagram illustrating the physical hardware connections between components of the spectrally tunable light source system.

FIG. 16 is a diagram illustrating multi-device synchronization architecture for coordinated lighting control across multiple devices.

FIG. 17 is a diagram illustrating mobile application interfaces for controlling the spectrally tunable light source system.

FIG. 18 is a block diagram illustrating a system architecture for a machine learning-capable device.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of lighting control systems will now be presented with reference to various apparatuses and methods. These apparatuses and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

Some approaches to controlling spectrally tunable lighting systems require complex mathematical calculations to determine an optimal combination of individual light source intensities, or intensity coefficients, needed to achieve a target spectrum. Light source, lighting source, light element, lighting element, and the like are used interchangeably in this disclosure. Some methods for computing these spectral mixes involve solving systems of linear equations or using optimization algorithms that must account for numerous variables including the spectral power distributions of each source, their intensity-dependent variations, and thermal effects. These computational approaches often demand significant processing resources and time. The resource-intensive nature of these calculations can limit the practical implementation of spectrally tunable lighting in applications that require low latency mixing with limited computational power.

Problems associated with energy consumption and the availability of computational resources, including hardware such as microprocessor modules, impact the feasibility of acquiring and deploying such systems. The systems and methods of the present disclosure reduce energy usage by shifting computational load to a pre-runtime stage, such as performing calculations at the factory or during manufacturing, thereby avoiding the need to perform such calculations each time the devices are powered on.

Thus, the disclosed systems and methods improve efficiency by employing a compute-once, run-many-times approach. Under this approach, devices may perform a retrieval operation of pre-computed values, which can be executed using simpler processing resources. For example, each lighting system incorporating spectrally tunable elements may include fewer modules or microprocessors than comparable systems lacking pre-computed values, thereby providing cost savings. In addition, the described improvements and optimizations enable more cost-effective designs and manufacturing methods for such lighting systems. Users of the disclosed lighting systems and methods also benefit from improved latency, as the systems provide more immediate response without needing to perform run-time computation.

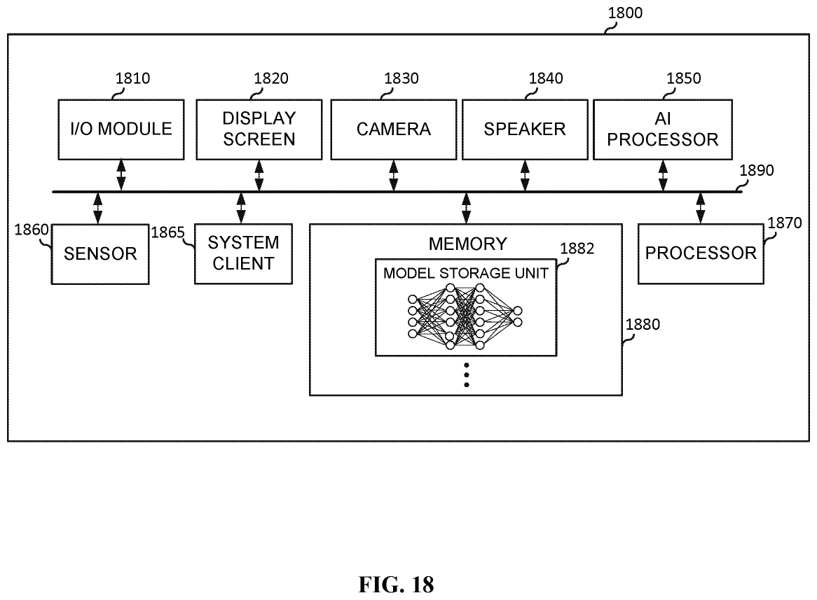

In other embodiments described below, methods and systems may also be provided using machine learning, where desired. In case of a machine learning approach, the systems and methods may function based on the device as shown in FIG. 18. Described are systems and methods (and techniques) for controlling spectrally tunable light sources through pre-computed simplex meshes, enabling real-time adjustment of spectral power distributions (an overall spectral output) while significantly reducing computational requirements compared to traditional optimization approaches. The systems and methods achieve this by shifting the computational burden of determining optimal spectral mixes from runtime to a preprocessing phase, where these mixes are calculated for strategic points within the desired control space and stored for efficient lookup and interpolation during operation.

In some embodiments, the system represents the achievable spectral control space as an n-dimensional simplex mesh, where each vertex corresponds to a pre-computed optimal mix of individual light source intensities. During operation, any desired spectral output within this control space can be achieved by identifying the simplex region containing the desired output point, and computing interpolation weights corresponding to each vertex of the identified simplex such that the desired output point is expressed as a weighted combination of the vertex values. Said interpolation weights may be determined by any method that yields an affine combination of the simplex vertices, including but not limited to: barycentric coordinate computation, solving a system of linear equations relating vertex positions to the target point, computing ratios of sub-simplex volumes or areas, matrix inversion methods, or iterative numerical approaches. The weights so determined possess the property that they sum to unity and, when applied to the pre-computed vertex values, reproduce the desired spectral output through weighted summation. By pre-computing optimal mixes at mesh vertices, the system reduces real-time computational complexity from an optimization problem to a simplex lookup operation followed by weighted interpolation.

The system supports arbitrary dimensionality in the control space, accommodating various spectral optimization targets. In a one-dimensional implementation, such as controlling correlated color temperature (CCT), the system may represent the control space as a series of pre-computed points along a line, with intermediate values obtained through interpolation between adjacent points. For two-dimensional control, such as xy chromaticity coordinates, the system subdivides the achievable color gamut into a mesh of triangular simplexes. This subdivision may be accomplished through an evenly spaced grid overlaid on the gamut, with special handling near gamut boundaries to ensure accurate representation of the achievable color space.

In some embodiments, the system employs a hierarchical lookup mechanism to efficiently identify the relevant simplex containing a desired target point. A regular grid of uniformly-sized cells is overlaid on the simplex mesh, enabling rapid coarse localization independent of the underlying simplex geometry. For a given target point, the system first maps the target coordinates to the containing grid cell, then iterates only through simplices intersecting that cell to identify the specific simplex for interpolation. This two-stage approach significantly reduces computational overhead compared to exhaustive search. Alternative spatial indexing structures such as k-d trees, quadtrees, octrees, or hash-based methods may be employed in place of or in combination with regular grids.

In some embodiments, the system employs adaptive mesh refinement during the pre-computation phase to minimize the number of vertices required while maintaining acceptable interpolation accuracy. The preprocessing module evaluates interpolation error across the control space by comparing interpolated values against computed optimal mixes at test points within each simplex. Regions exhibiting interpolation error exceeding a specified threshold are subdivided into smaller simplexes, while regions where linear interpolation provides sufficient accuracy retain larger simplexes. This refinement process may be applied iteratively until all regions satisfy accuracy requirements or until a maximum vertex count is reached. The resulting simplex mesh exhibits varying density across the control space, with higher vertex concentration in regions of rapid spectral variation and lower concentration in regions amenable to linear approximation.

In some embodiments, machine learning techniques enhance the preprocessing phase. Machine learning models may determine optimal vertex placement to minimize interpolation error while constraining total vertex count. Models trained on successful mesh configurations may propose initial mesh structures requiring less optimization to achieve target accuracy. These machine learning enhancements operate during preprocessing and do not affect runtime interpolation operations.

The system further extends to higher-dimensional control spaces, enabling simultaneous optimization of multiple spectral characteristics. For instance, a three-dimensional implementation might combine xy chromaticity control with optimization of melanopic index, allowing for precise control of both visual and non-visual effects of the spectral output. The system maintains computational efficiency in higher dimensions through careful consideration of simplex subdivision strategies and lookup mechanisms.

In some embodiments, the control space includes dimensions targeting non-visual biological effects of light. The system may optimize for melanopic equivalent daylight illuminance (M-EDI), circadian stimulus (CS), or other metrics quantifying impact on human circadian rhythms. For example, a two-dimensional control space may include correlated color temperature (CCT) along one axis and melanopic index along another, enabling independent control of visual appearance and biological impact. Integration with circadian schedule generators may automatically adjust target coordinates throughout the day to support healthy sleep-wake cycles. The target coordinate trajectory through the control space over a 24-hour period determines the spectral output at each time of day, with corresponding variations in both color temperature and melanopic index.

In some embodiments, the system includes specific handling for boundary conditions where the desired control space intersects with physical limitations of the light sources. This may involve specialized subdivision strategies near boundaries to accurately represent the achievable range while maintaining computational efficiency. The system may also include methods for graceful degradation when requested target values lie outside the achievable range, such as finding the nearest achievable point within the pre-computed mesh.

In some embodiments, the system incorporates sensor feedback to automatically adjust target coordinates or compensate final spectral mixes. Thermal sensors integrated with the light-emitting elements enable compensation for temperature-dependent variations in spectral output. Ambient light sensors measure environmental illumination for daylight-responsive adjustment. Occupancy sensors trigger lighting scenes based on presence detection. Color sensors or spectrometers may measure actual spectral output, enabling closed-loop calibration that compensates for LED aging or manufacturing variations. Sensor feedback may be applied at the input stage by modifying target coordinates prior to lookup and interpolation, or at the output stage by adjusting the final spectral mix values after interpolation.

Accordingly, the methods and systems described herein provide a computationally efficient method for controlling spectrally tunable light sources in real-time applications, particularly suitable for embedded systems or other scenarios where computational resources are limited. By shifting complex optimization calculations to a pre-computation phase and employing efficient geometric interpolation during runtime, the system enables precise spectral control while maintaining rapid response times and minimal computational overhead.

In some embodiments, the system architecture employs a distributed computational approach wherein the preprocessing phase operates on an off-device microprocessor, while the runtime control executes on a dedicated microcontroller unit (MCU) within the lighting device itself. This separation enables efficient resource allocation, with the computationally intensive preprocessing tasks leveraging the potentially greater resources of the host system, while the time-sensitive runtime operations benefit from the dedicated, low-latency processing capabilities of the on-device MCU. The host microprocessors executes the preprocessing module, mesh generation, and data structure generation, storing intermediate results in volatile memory and persisting the final data structure to non-volatile memory. This data structure is then transferred to non-volatile memory that can be accessed by the lighting device MCU. The lighting device MCU executes the runtime controller, which accesses the pre-computed data structures from non-volatile memory and stores intermediate calculations in volatile memory. The lighting device further includes dedicated LED controllers that receive commands from the lighting device MCU, store these commands in volatile memory, and apply the resulting configurations to the individual light-emitting elements based on timing signals from the device MCU.

In some embodiments, runtime lookup and interpolation operations are performed entirely in software on the lighting device microcontroller. In other embodiments, dedicated hardware accelerates these operations, including but not limited to programmable logic devices, application-specific integrated circuits, digital signal processors, graphics processing units, or other specialized computational elements. Hybrid implementations may combine software control logic with hardware-accelerated mathematical operations. The distribution of computational tasks between software and hardware may be static or dynamically adjusted based on system load or power constraints.

In some embodiments, the preprocessing phase may be executed in computing environments beyond a dedicated host computer, including cloud-based servers, mobile devices, edge computing nodes, or the lighting device itself when sufficient resources are available. The preprocessing system may be centralized to serve multiple lighting devices, distributed across network nodes, or localized to individual devices.

In some embodiments, the pre-computed data structure is transferred from the preprocessing system to the lighting device via wired connections, wireless protocols, network protocols, or removable storage media. The data structure may be transferred in full during initial configuration, incrementally as partial updates, or streamed in portions during operation to enable dynamic reconfiguration.

In some embodiments, multiple spectrally tunable lighting devices operate in coordinated fashion under a central controller or distributed consensus protocol. Synchronization of target coordinates across devices creates uniform illumination or coordinated effects across multiple zones. Each device may maintain device-specific mesh structures while presenting a unified control interface. Time synchronization enables choreographed transitions where devices independently interpolate through target coordinate sequences according to shared timing references.

In some embodiments, the system exposes application programming interfaces enabling third-party control of spectral output. Mobile applications may provide user interfaces for target coordinate selection within the control space. A single lighting device may store multiple simplex mesh structures, each representing a different control space configuration. For example, one mesh may enable two-dimensional control via xy chromaticity coordinates, while another mesh may enable one-dimensional control via correlated color temperature (CCT). The mobile application may allow the user to select between available control modes, with each mode corresponding to a different on-device simplex mesh. The mobile application may also enable the user to upload or update simplex mesh structures on the lighting device, allowing deployment of revised mesh configurations, additional control space dimensions, or corrections for manufacturing variations.

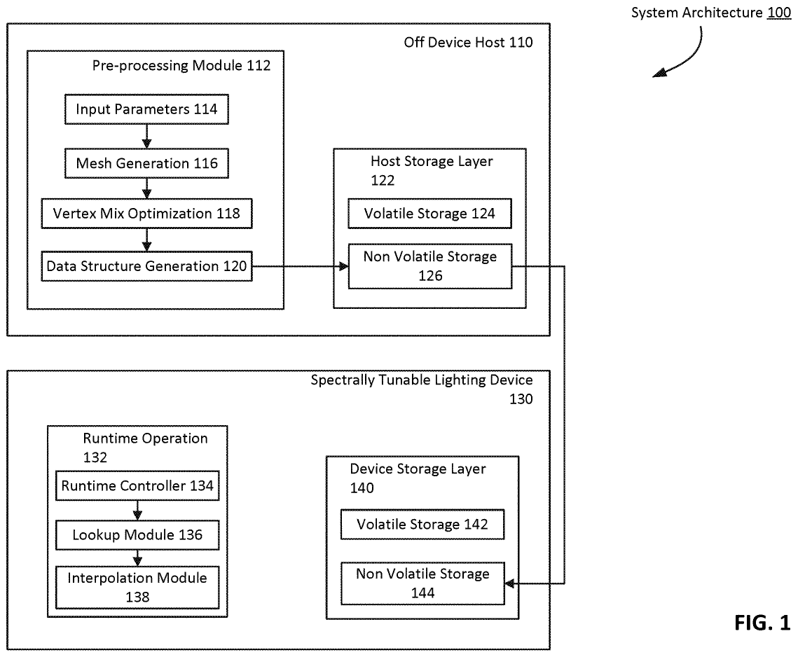

FIG. 1 is a block diagram illustrating the overall system architecture 100 for generating and utilizing pre-computed spectral mixes. The system architecture employs a distributed computational model across multiple processing units. The system comprises an off device host 110 and a spectrally tunable lighting device 130. Within the off device host 110, the pre-processing module 112 executes on an off-device host microprocessor, operating from code stored in the host's non-volatile memory and utilizing the host's volatile memory for intermediate calculations. The pre-processing module 112 processes input parameters 114, including control space definitions and light source characteristics. Given these input parameters, the mesh generation unit 116, also executing on the host microprocessor from code in non-volatile memory and storing data in volatile memory, produces a simplex mesh. Similarly, the vertex mix optimization module 118, executing on the host microprocessor, computes optimal spectral mixes for each vertex within the generated simplex mesh. In some embodiments, the vertex may be referred to as coordinates on the mesh graph or plot, coefficients, intensity coefficients, parameters or the like. The vertex may correspond to a power or voltage input for each light element. The data structure generation module 120, likewise running on the host microprocessor, creates the runtime lookup structure, which is initially stored in the host storage layer 122, specifically in non volatile storage 126. This pre-computed data structure is subsequently transferred to the non volatile storage 144 within the device storage layer 140 of the spectrally tunable lighting device 130 for runtime access. During operation, the runtime operation module 132, executing on the lighting device MCU from code stored in the device's non-volatile memory, processes target coordinates through the runtime controller 134, lookup module 136, and interpolation module 138 to produce final spectral mixes. The runtime operation module 132 may utilize volatile storage 142 on the lighting device to cache metadata or previously computed mixes to further accelerate the mix generation performance. The final spectral mix commands are then transmitted to dedicated LED controllers on the lighting device, which store these commands in volatile memory and apply them to the individual light-emitting elements upon receiving appropriate timing signals from the lighting device MCU.

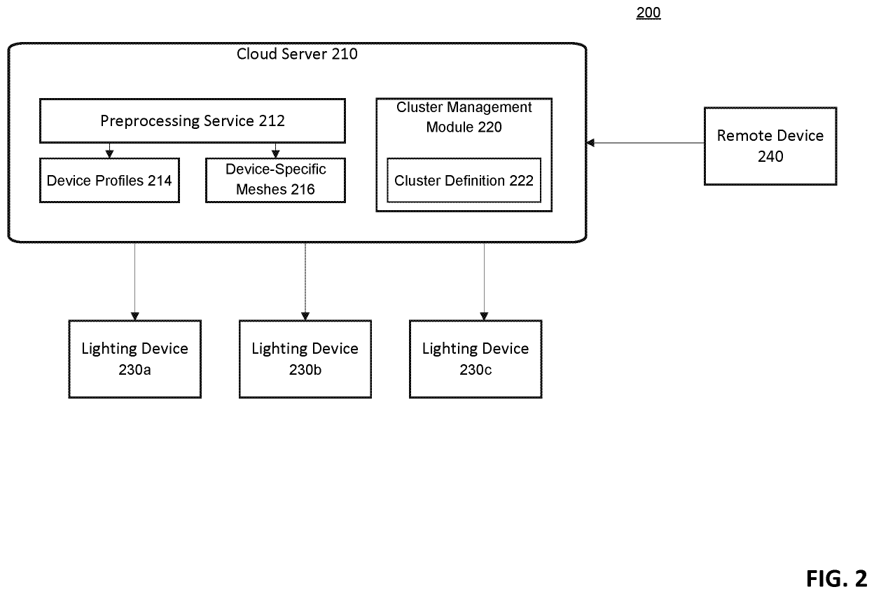

FIG. 2 is a block diagram illustrating a cloud-based architecture 200 extending the system of FIG. 1. The preprocessing operations described in FIG. 1 may alternatively be performed on a cloud server 210. A preprocessing service 212 on the cloud server 210 generates device-specific simplex meshes for each connected lighting device. Because individual devices may contain light-emitting elements with varying spectral characteristics due to manufacturing tolerances or component selection, the preprocessing service 212 maintains device profiles 214 storing the spectral parameters unique to each device, and generates device-specific meshes 216 optimized for each device's particular light-emitting elements.

The cloud server 210 further enables a cluster management module 220 that allows multiple lighting devices to be addressed as a singular logical device. The cluster management module 220 maintains a cluster definition 222 specifying which physical devices comprise the cluster. Upon receiving cluster-level target coordinates, the module translates these into device-specific targets for each member device. Lighting devices 230a-c connect to the cloud server 210 to receive mesh data and target coordinates, executing runtime operations independently as described in FIG. 1. Device-specific meshes 216 may be dynamically updated on lighting devices 230a-c in response to calibration changes, component aging, environmental conditions, or modifications to optimization targets. A remote device 240 may control the optimization process and resulting spectral output through the cloud server 210.

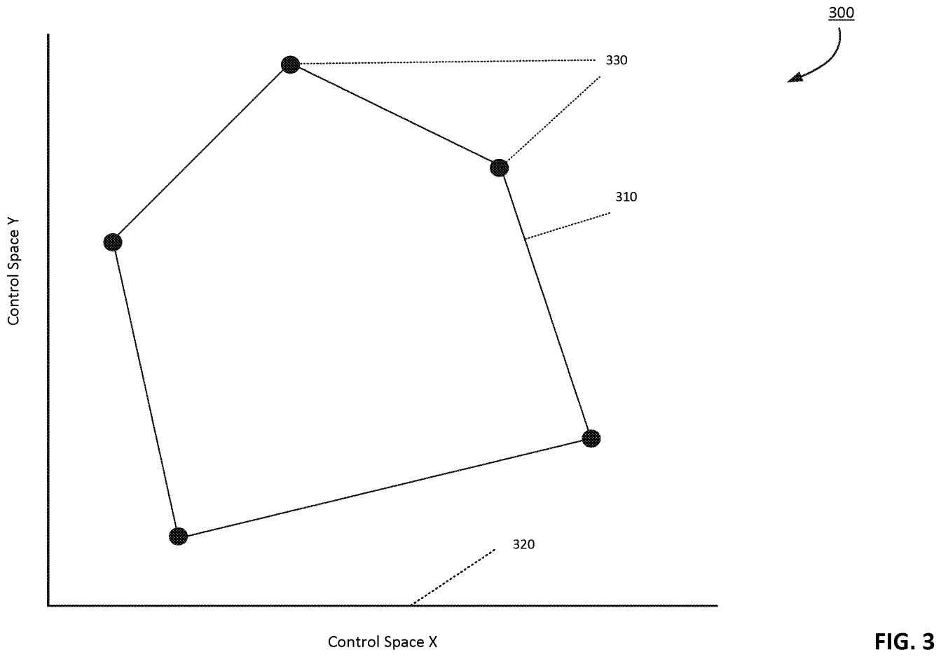

FIG. 3 is a graph 300 illustrating a two-dimensional control space with the boundary of achievable values 310 plotted within a coordinate system 320. Individual light source locations 330 within the control space are marked, defining the outer limits of the control space with the coordinate system. The boundary of achievable values is dependent on the optimization target, and is not inherently limited to the bounding volume of the individual light source locations within the control space. The individual light source may be characterized by a spectral response when powered by a voltage input, which may be described as an intensity coefficient. The spectral response output is a function of the intensity coefficient input. A total or overall spectral output is determined by the combination of the spectral output of the individual light source elements.

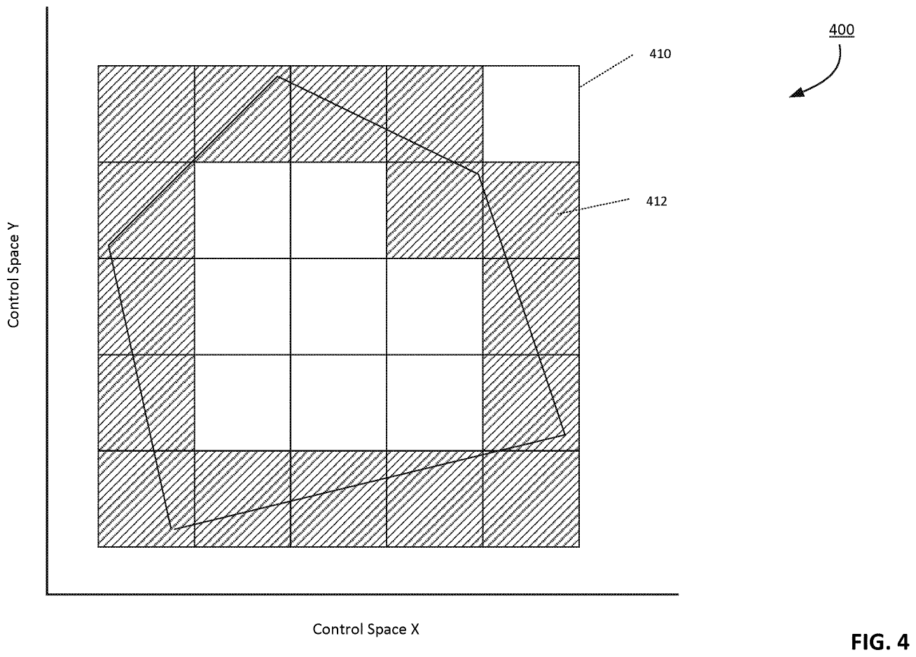

FIG. 4 is a graph 400 illustrating the overlay of a regular grid structure 410 onto the control space. The grid cells 412 that intersect with the boundary 310 are highlighted to indicate the simplex subdivision method varies between boundary and fully interior grid cells.

For each fully interior cell, a single anchor vertex is chosen that will be included in all subdivided simplexes. This method of selection of this anchor vertex is arbitrary. Simplex division is achieved via constructing a new edge between the anchor vertex and every other non-neighboring vertex.

For each cell that contains a boundary of the achievable control area, a set of vertices is collected that is the combined set of i) all grid cell vertices that are fully contained within the achievable control area ii) all vertices of the boundary of the achievable control area that are contained with the cell iii) all intersection points between the boundary of the achievable control area and the boundary of the cell. From this set of vertices, a single anchor vertex is chosen that will be included in all subdivided simplexes. This method of selection of this anchor vertex is arbitrary. Simplex division is achieved via constructing a new edge between the anchor vertex and every other non-neighboring vertex.

For higher dimension control spaces, the simplex mesh must be generated recursively. For example, in a three dimensional cell each face of the cell must first undergo simplex subdivision before the volume of the cell undergoes simplex subdivision. The process of subdividing higher dimension cells remains the same in that a single anchor vertex is chosen, and new edge is constructed between the anchor vertex and every other non-neighboring vertex.

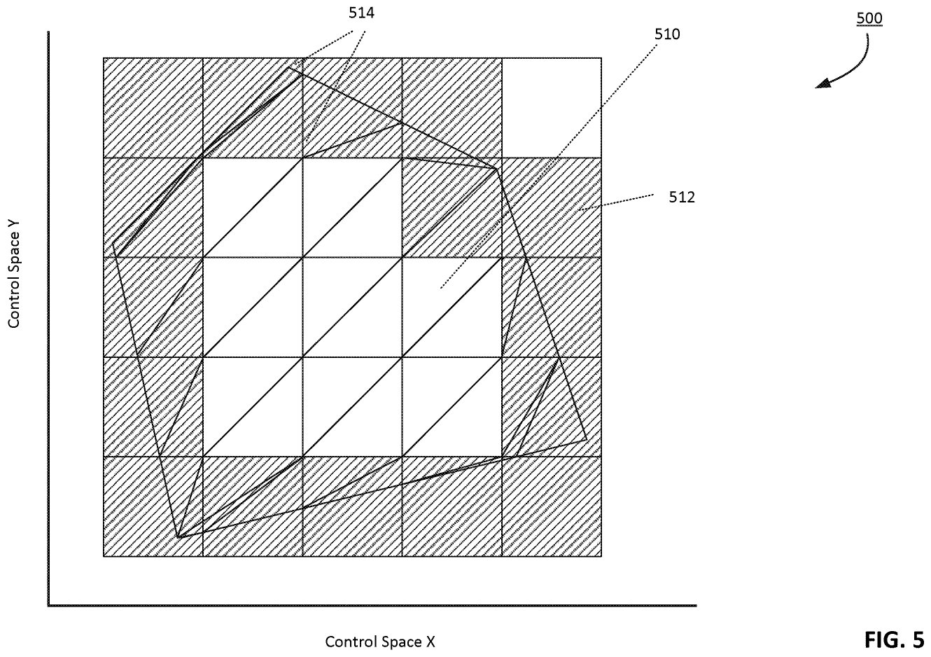

FIG. 5 is a graph 500 illustrating the final simplex mesh with interior cells 510 maintaining uniform simplex subdivision, while boundary cells 512 are divided into an independent set of simplexes. The vertices of the simplex mesh 514 are utilized as the target values within the control space during mix optimization.

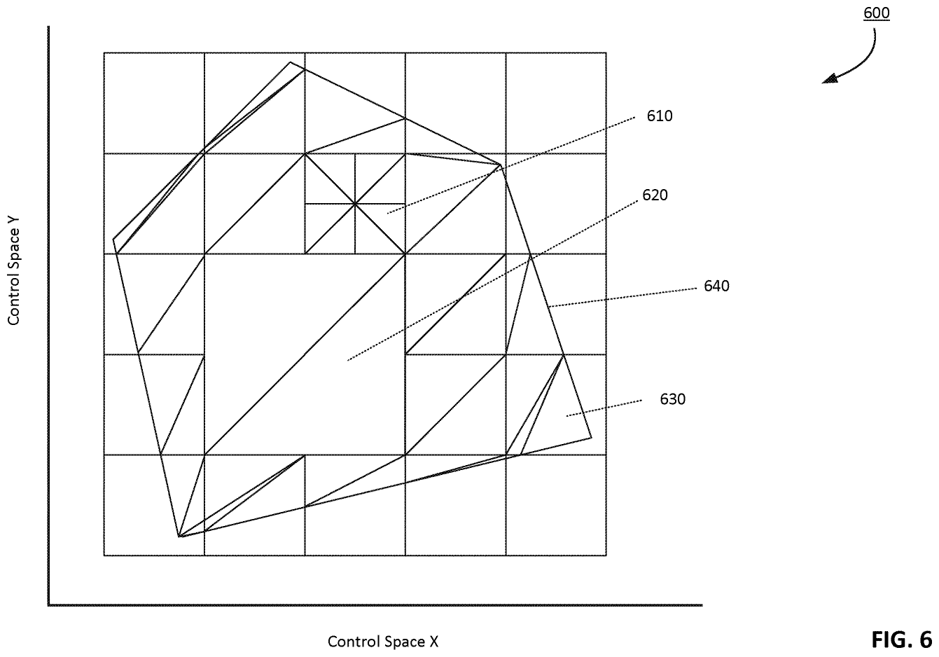

FIG. 6 is a graph 600 illustrating adaptive mesh refinement within a two-dimensional control space. As described previously, the system may employ adaptive mesh refinement during preprocessing to minimize the number of vertices required while maintaining acceptable interpolation accuracy. The preprocessing module evaluates interpolation error by comparing interpolated values against computed optimal mixes at test points within each simplex. Regions exhibiting error exceeding a specified threshold are subdivided into smaller simplexes, and this process may be applied iteratively until accuracy requirements are satisfied or a maximum vertex count is reached.

When adaptive mesh refinement is applied, the resulting simplex mesh exhibits varying density across regions of the control space. A high density region 610 contains densely packed simplexes providing fine interpolation resolution in areas where spectral response varies rapidly or where interpolation error would otherwise exceed acceptable thresholds. A low density region 620 contains larger simplexes in areas where linear interpolation between vertices provides sufficient accuracy. A transition region 630 exhibits intermediate simplex density near the gamut boundary 640, which corresponds to the boundary of achievable values 310 in FIG. 3.

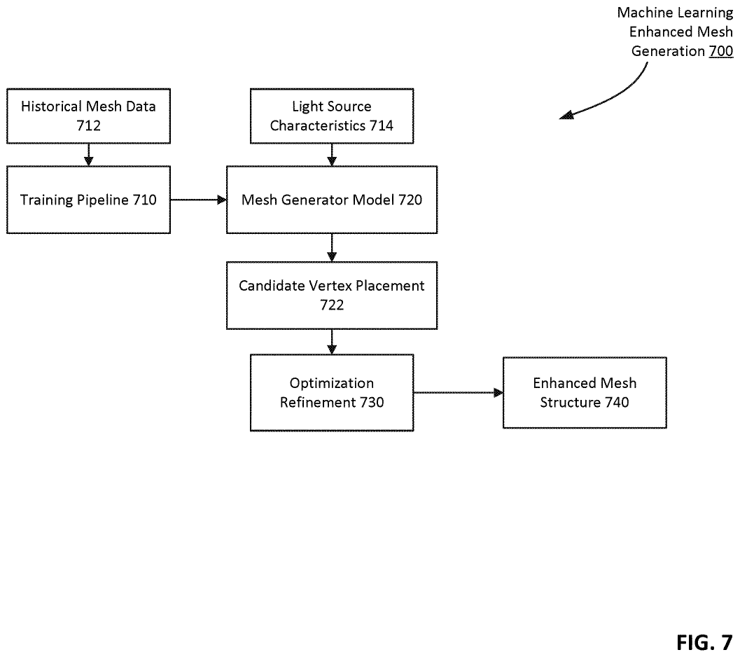

FIG. 7 is a block diagram 700 illustrating machine learning enhanced mesh generation during the preprocessing phase. A training pipeline 710 processes historical mesh data 712 and corresponding accuracy metrics to train a mesh generator model 720. The mesh generator model 720 receives light source characteristics 714 as input and produces candidate vertex placements 722 within the control space. These candidate placements are passed to an optimization refinement module 730, which computes optimal spectral mixes for each vertex using traditional optimization as described in FIG. 1. The resulting enhanced mesh structure 740 is transferred to the lighting device for runtime operation. Refinement outcomes may be fed back to the training pipeline 710 to iteratively improve vertex placement predictions.

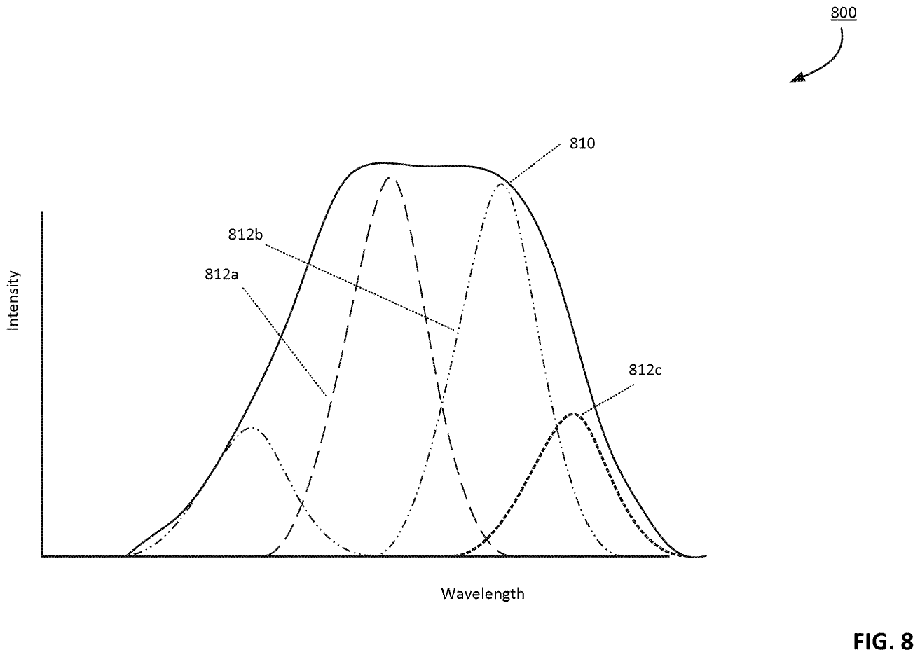

FIG. 8 is a diagram 800 illustrating the spectral mix generated for a simplex mesh vertex via optimization. The spectral distribution of the overall emittance of the spectrally tunable light source 810 is the sum of the emittance of each individual light source 812 source within the spectrally tunable light source.

Optimization is utilized to determine the intensity level for each individual light source 812 source within the spectrally tunable light source. Optimization is complete when the spectral distribution of the overall emittance of the spectrally tunable light source best matches the values specified by the simplex mesh vertex coordinates within the control space. Optimization can also be considered complete after a predetermined amount of time if a best match cannot be found.

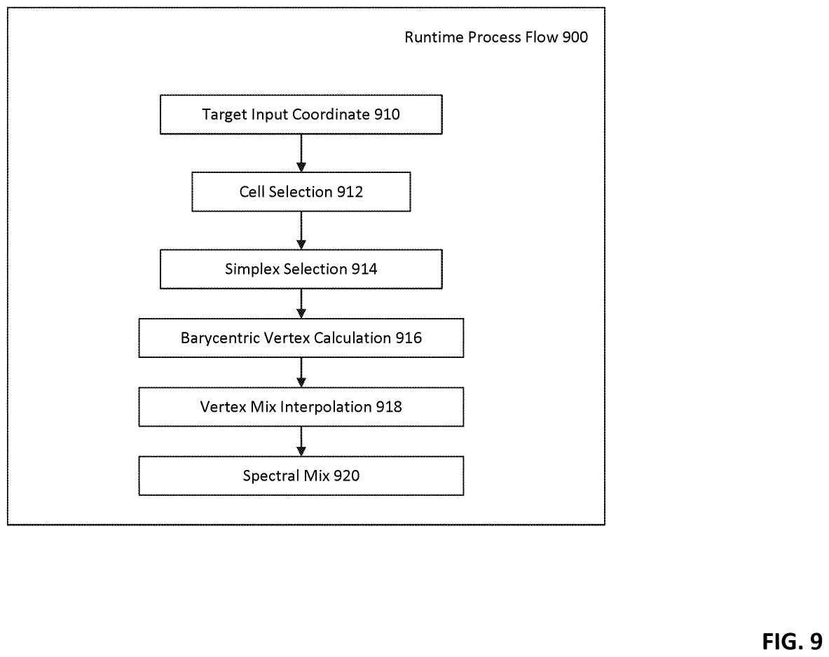

FIG. 9 is a block diagram 900 illustrating the runtime process flow, beginning with target coordinate input 910. The cell selection module 912 determines the grid cell, that contains the target coordinate. If the target coordinate lies outside the boundary of achievable values, the cell identification module can either reject the target coordinate or, via a secondary process, map the invalid target coordinate to a target coordinate that lies within the boundary of achievable values. After a candidate cell has been selected, simplex selection module 914 will determine which of the cell's simplexes contain the target coordinate. This selection is conducted via enumeration of the possible simplexes, stopping when a simplex is found to contain the target coordinate. The barycentric vertex calculation module 916 determines the barycentric coordinates of the target coordinate within the simplex selected in the previous step. The vertex mix interpolation module 918 calculates the final spectral mix 920 by utilizing the previously computed barycentric coordinates to scale the precomputed mix of each of the simplex's vertices.

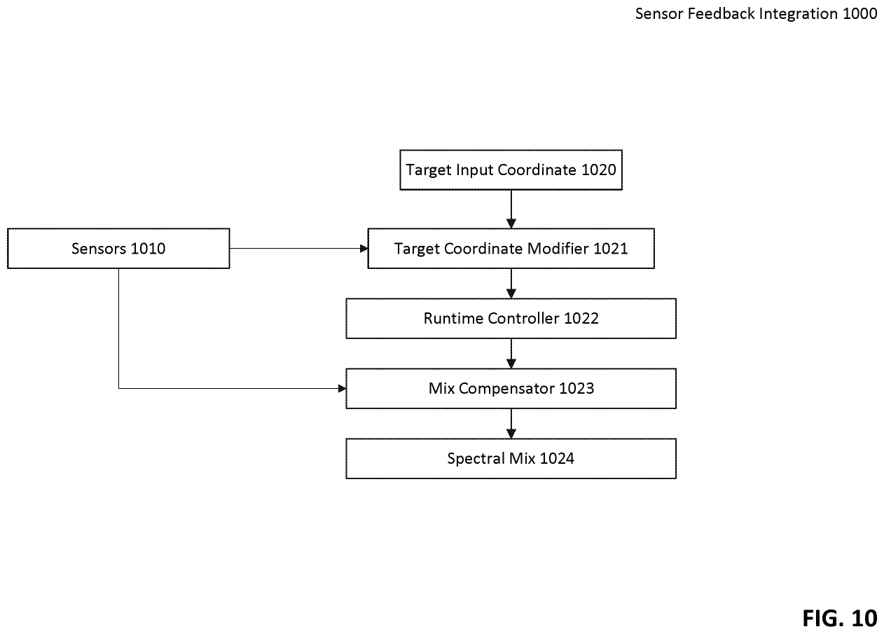

FIG. 10 illustrates sensor feedback integration 1000 for adaptive control during runtime operation. Sensors 1010 provide feedback data to the runtime system, including thermal sensors for temperature compensation, ambient light sensors for daylight response, occupancy sensors for presence detection, and color sensors for closed-loop calibration. The runtime controller 1021 corresponds to the runtime controller 134 in FIG. 1 and processes sensor data to adjust system operation.

Sensor feedback may be applied at two stages of the runtime process. A target coordinate modifier 1021 adjusts input coordinates prior to lookup and interpolation based on sensor inputs, enabling automatic scene selection or daylight-responsive target adjustment. A mix compensator 1023 adjusts output values after interpolation, enabling temperature compensation or calibration correction without modifying the target coordinates. The spectral mix 1024 reflects the combined effect of the pre-computed mesh interpolation and any sensor-driven adjustments.

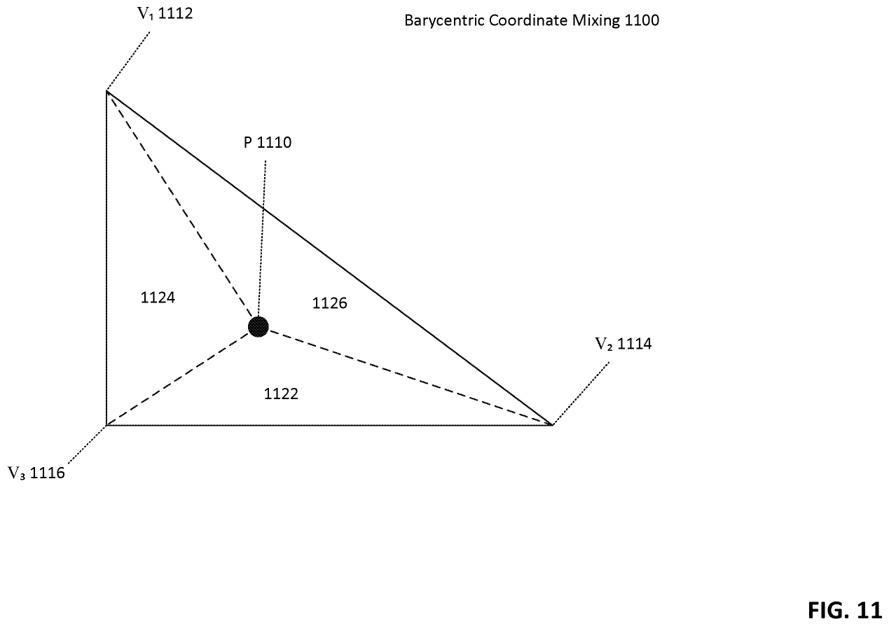

FIG. 11 illustrates the barycentric coordinate calculation and vertex mixing process. For a target point P 1110 within a simplex formed by vertices V₁ 1112, V₂ 1114, and V₃ 1116, the point P can be expressed as a weighted sum of the vertices according to the following equation:

$$P = {λ}^{1} {V}^{1} + {λ}^{2} {V}^{2} + {λ}^{3} {V}^{3} \qquad ( 1 )$$

where λ₁, λ₂, and λ₃ are the barycentric coordinates satisfying: λ₁+λ₂+λ₃=1 and λᵢ≥0 for all i
   In the two-dimensional case, the barycentric coordinates can be computed using the following formulas:

$${λ}^{1} = \frac{Area ( △ {PV}^{2} {V}^{3} )}{Area ( △ {V}^{1} {V}^{2} {V}^{3} )} \qquad ( 2 )$$

$${λ}^{2} = \frac{Area ( △ {PV}^{1} {V}^{3} )}{Area ( △ {V}^{1} {V}^{2} {V}^{3} )} \qquad ( 3 )$$

$${λ}^{3} = \frac{Area ( △ {PV}^{1} {V}^{2} )}{Area ( △ {V}^{1} {V}^{2} {V}^{3} )} \qquad ( 4 )$$

where Area(^{Δ}ABC) represents the area of the triangle formed by points A, B, and C. The resulting barycentric coordinates are then used as weights in scaling the intensity of the mixes precomputed for each of the simplex's vertices. The resulting spectral mix being:

$$MIX = {λ}_{1} \cdot {MIX}_{1} + {λ}_{2} \cdot {MIX}_{2} + {λ}_{3} \cdot {MIX}_{3}$$

where MIXᵢ represents the precomputed spectral mix for vertex Vᵢ.

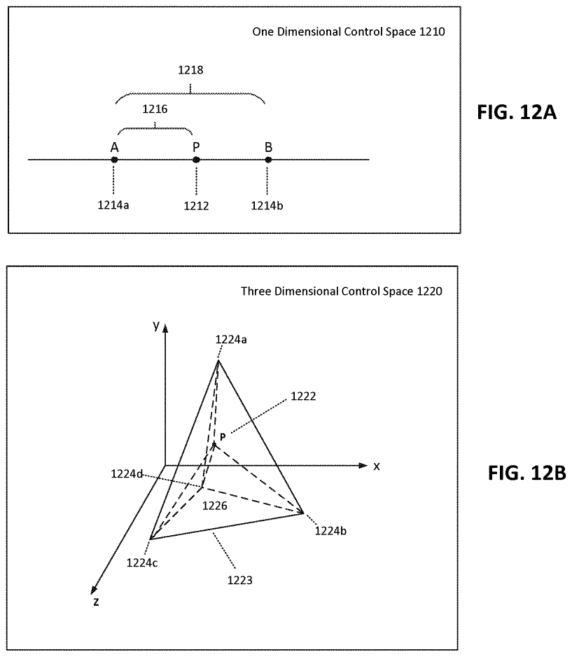

FIG. 12A is a diagram illustrating the dimensional flexibility of the approach in a one-dimensional control space. FIG. 12B is a diagram illustrating the dimensional flexibility of the approach in a three-dimensional control space. In the one-dimensional control space case 1210, for a target coordinate P 1212 between two pre-computed vertex coordinates A and B (both labeled as 1214), the barycentric coordinates reduce to:

$${λ}_{a} = \frac{\vert P - B \vert}{\vert A - B \vert} \qquad ( 5 )$$

$${λ}_{β} = \frac{\vert P - A \vert}{\vert A - B \vert} \qquad ( 6 )$$

where |P−B| represents the distance from point P to point B 1216, and |A−B| represents the total distance between vertices A and B 1218.

In the three-dimensional control space 1220, for a target coordinate P 1222 contained within a tetrahedron simplex formed from four vertex coordinates Vᵢ 1224, the barycentric coordinates 2 are computed using the ratio of volumes:

$${λ}_{i} = \frac{Volume ( Tetrahedron formed by P and all vertices except {V}_{i} )}{Volume ( Original tetrahedron )} \qquad ( 7 )$$

The same principle extends to higher dimensions, where the barycentric coordinates are determined by the ratio of the hypervolume of the simplex formed by the target point and a subset of vertices to the hypervolume of the original simplex.

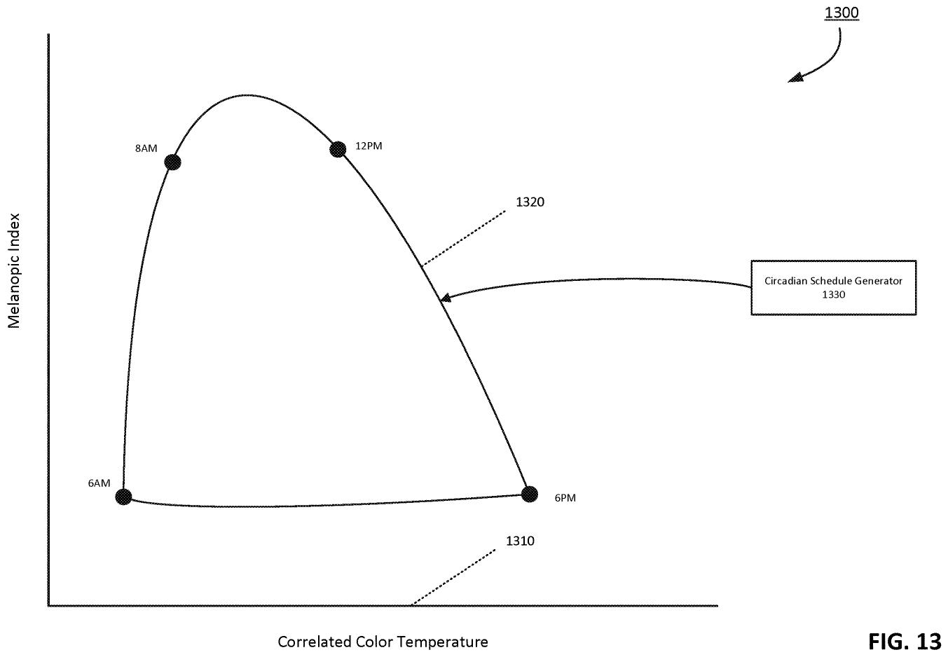

FIG. 13 illustrates circadian rhythm control 1300 using the simplex mesh system. A control space 1310 includes dimensions for correlated color temperature (CCT) and melanopic index. A coordinate trajectory 1320 traces the path of target coordinates through the control space over a 24-hour period. The trajectory passes through regions of the control space with high melanopic index during morning hours to promote alertness, transitions through neutral values during midday, and shifts to low melanopic index during evening hours to support healthy sleep onset. A circadian schedule generator 1330 may automatically determine the coordinate trajectory based on time of day, user preferences, or external inputs.

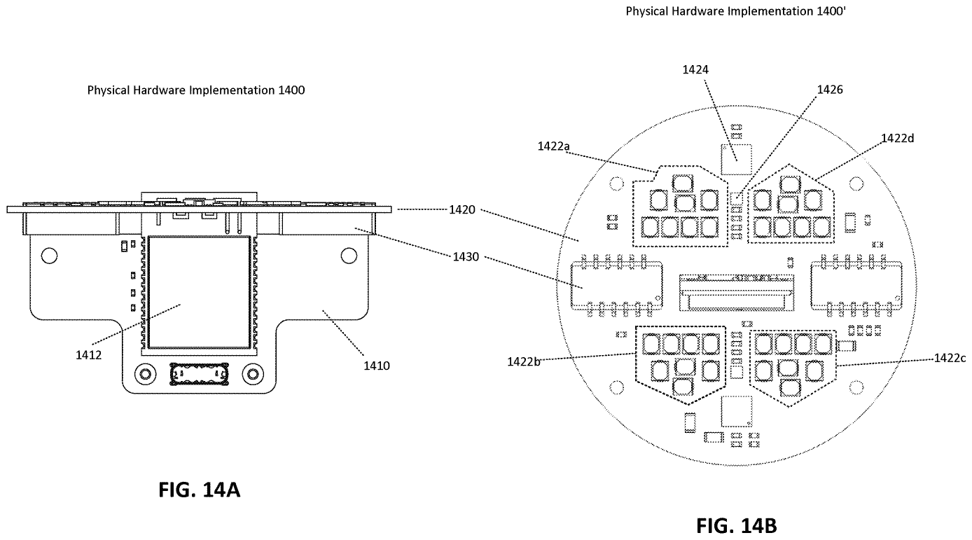

FIG. 14A is a diagram illustrating a side view of the dual PCB electrical implementation of the spectrally tunable light source system 1400. FIG. 14B is a diagram illustrating a top view of the LED PCB of the spectrally tunable light source system. The system employs a dual printed circuit board (PCB) architecture comprising a main controller PCB 1410 and a separate LED PCB 1420. This design approach enables optimal thermal and electrical isolation between the high-power light-emitting elements and the sensitive control electronics.

The main controller PCB 1410 houses the primary microcontroller 1412 that executes the runtime algorithms described previously. The microcontroller contains non-volatile storage that stores the pre-computed simplex mesh and associated spectral mixes previously generated by the off-device host microprocessor during the preprocessing phase and transferred to the lighting device. The primary microcontroller 1412 runs the runtime controller code stored in its own non-volatile memory, accessing the pre-computed data structures from connected non-volatile storage, and utilizing its volatile memory for intermediate calculations during the lookup and interpolation processes. This microcontroller may be implemented using a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein.

The LED PCB 1420 contains multiple light-emitting elements 1422 of various spectral characteristics (wavelengths). In some embodiments, the light-emitting elements include a minimum of three distinct wavelength sources to enable full coverage of a two-dimensional chromaticity control space. Higher-dimensional control spaces may require additional distinct wavelength sources. The light-emitting elements are arranged in a circular configuration to optimize thermal distribution.

The LED PCB 1420 also incorporates dedicated LED controller integrated circuits 1424 that receive commands from the main microcontroller and provide precise current and duty cycle control to each individual light-emitting element. These LED controllers store the received commands in volatile memory and apply these configurations to the LEDs upon receiving appropriate timing signals from the main microcontroller. The LED controller chips may include pulse-width modulation (PWM) controllers, digital-to-analog converters (DACs), and current amplifiers to achieve high-precision control over the intensity of each individual light source.

The main controller PCB 1410 connects to the LED PCB 1420 through a digital communication interface 1430, which may utilize serial protocols such as I²C, SPI, or a custom protocol. This interface carries the intensity commands calculated by the microcontroller to the LED controller chips.

Thermal sensors 1426 are integrated into the LED PCB to monitor the operating temperature of the light-emitting elements. These temperature readings are transmitted back to the main microcontroller through the communication interface 1430, allowing the system to adjust driving parameters to compensate for temperature-dependent variations in spectral output characteristics and ensuring consistent performance across varying environmental conditions.

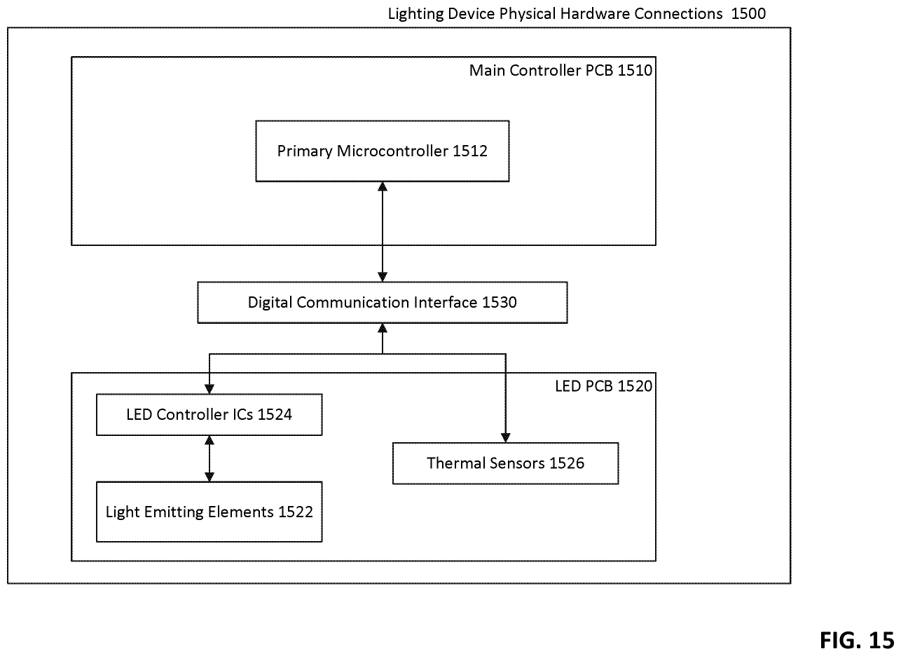

FIG. 15 is a block diagram illustrating the physical hardware connections 1500 of the spectrally tunable light source system and the computational distribution across the system components. The diagram depicts the two-PCB architecture and the communication pathways between key components. The main controller pcb 1510 houses the primary microcontroller 1512, which serves as the central processing unit for the runtime operations of the system. This microcontroller executes the runtime controller code stored in its non-volatile memory, accessing pre-computed data structures from connected non-volatile storage and utilizing its volatile memory for intermediate calculations. The primary microcontroller connects to the digital communication interface 1530, which facilitates bidirectional data transfer between the two printed circuit boards.

On the LED PCB 1520, the LED controller ICs 1524 receive control signals from the primary microcontroller through the digital communication interface. These controllers store the received commands in their volatile memory and apply these configurations to the light emitting elements 1522 based on timing signals from the primary microcontroller. The LED PCB also contains thermal sensors 1526 that monitor operating temperatures and transmit this data back to the primary microcontroller via the digital communication interface 1530.

Not shown in the physical hardware diagram, but integral to the system's operation, is the off-device host microprocessor that performs the preprocessing phase operations including mesh generation, optimization, and data structure generation. This host microprocessor executes code stored in its non-volatile memory, utilizes its volatile memory for intermediate calculations, and stores the resulting data structures in its own non-volatile memory. These data structures are subsequently transferred to the non-volatile memory of the primary microcontroller 1512 of the lighting device for runtime access.

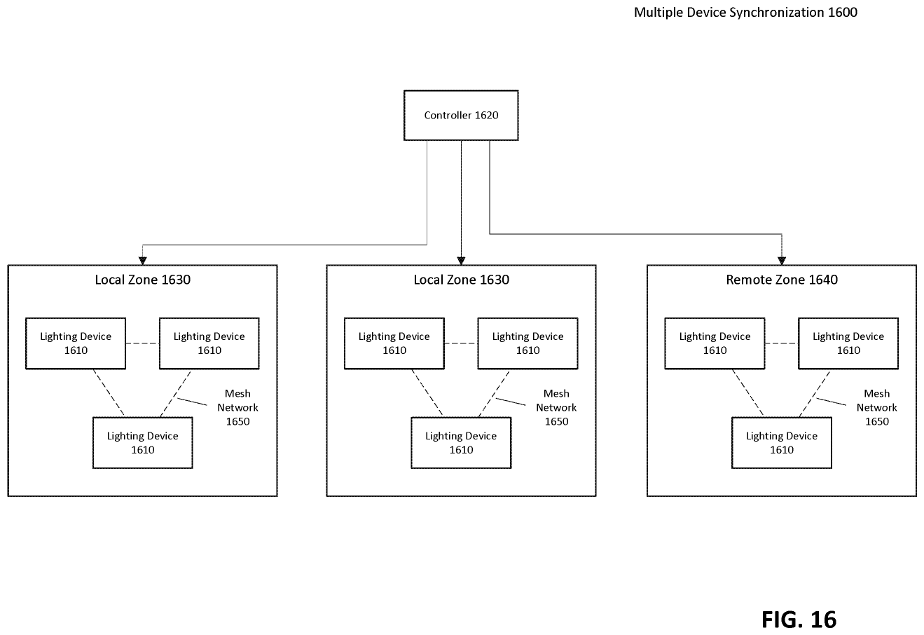

FIG. 16 illustrates multi-device synchronization architecture 1600. Multiple lighting devices 1610, each maintaining device-specific mesh structures, connect to a controller 1620. The controller 1620 may be a central hub or the devices may coordinate via a distributed consensus protocol. The controller 1620 distributes target coordinates and timing references to the lighting devices 1610, enabling synchronized spectral output across devices.

Zone groupings 1630 organize devices into logical control groups, allowing coordinated effects within zones while maintaining independent control between zones. Within each zone, devices may form a mesh network 1650 enabling direct device-to-device communication and local time synchronization. The mesh network 1650 maintains timing synchronization among devices within a zone independent of the controller 1620. The controller 1620 provides a timing reference that synchronizes multiple zones together, enabling choreographed transitions across zones regardless of physical location.

Remote zone 1640 represents devices at a geographically separate location connected to the controller 1620 via the internet. The controller 1620 may coordinate devices across remote locations through network connections, enabling synchronized lighting control across physically separated spaces such as multiple retail locations, distributed office buildings, or franchise deployments. Each zone maintains local time synchronization via its mesh network 1650, while the controller 1620 synchronizes zones together through distributed timing references.

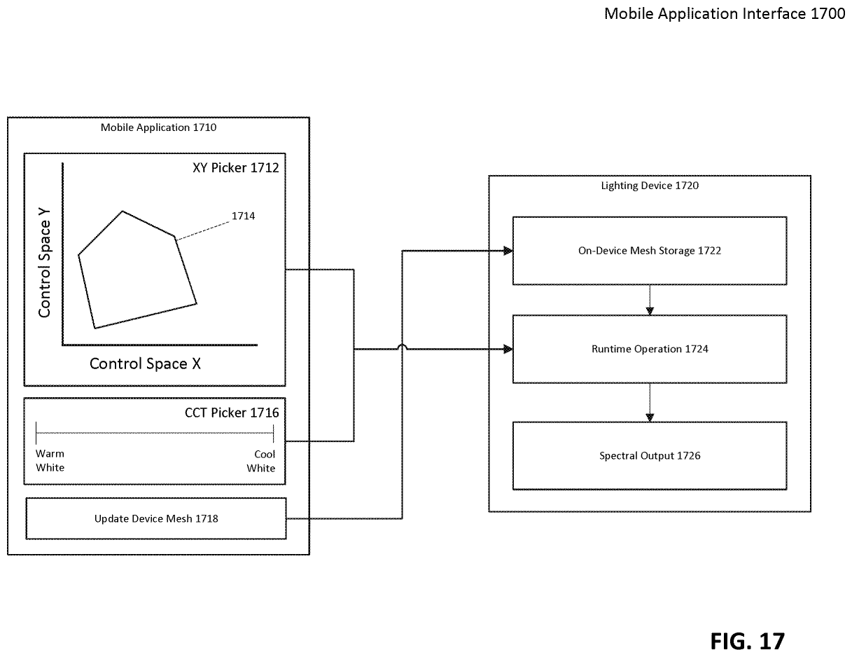

FIG. 17 illustrates a mobile application interface 1700 for controlling the spectrally tunable light source system. A mobile application 1710 provides multiple control modes corresponding to different simplex mesh structures stored on the lighting device 1720.

An XY color picker 1712 displays a two-dimensional control space representing xy chromaticity coordinates. The XY color picker 1712 shows the gamut boundary 1714 corresponding to the boundary of achievable values for the connected lighting device. When target coordinates are received via the XY color picker 1712, the lighting device 1720 utilizes a two-dimensional simplex mesh stored in on-device mesh storage 1722 for lookup and interpolation. A CCT picker 1716 displays a one-dimensional control space representing correlated color temperature. The CCT picker 1716 allows selection of color temperature along a scale from warm to cool values. When target coordinates are received via the CCT picker 1716, the lighting device 1720 utilizes a one-dimensional simplex mesh stored in on-device mesh storage 1722 for lookup and interpolation.

Runtime operation 1724 selects the appropriate mesh from on-device mesh storage 1722 based on the dimensionality of the received target coordinates or other explicit configuration parameters. Runtime operation 1724 corresponds to runtime operation 132 in FIG. 1. The on-device mesh storage 1722 may contain multiple mesh structures for different control modes. Runtime operation 1724 produces a spectral output 1726 based on the interpolated spectral mix generated from the selected mesh.

A mesh update control 1718 enables the user to upload or update simplex mesh structures on the lighting device 1720. The mesh update control 1718 may transfer revised mesh configurations from the mobile application 1710 or a cloud server to the on-device mesh storage 1722, enabling deployment of updated meshes, additional control modes, or device-specific calibration corrections.

FIG. 18 is an exemplary block diagram 1800 of a control module or processing unit device for controlling a machine learning or artificial intelligence device (e.g., a device used for determining optimization of a spectrally tunable lighting system), according to an embodiment of the disclosure. In this disclosure artificial intelligence and machine learning may be used interchangeably.

The module 1800 may be implemented by a stationary device or a mobile device, such as a computer, a mobile device, a smartphone, a desktop computer, a notebook, a tablet computer, a personal digital assistant (PDA), a wearable device, a radio, a robot, a vehicle, and the like. It will be appreciated by those skilled in the art that the module may be a remote module with processing performed remotely. The device may receive the instructions and commands from a remote module. In some cases, the device may run a simplified system to offload processing for distributed processing, to send data or information for a centralized remote server to process, etc.

Referring to FIG. 18, the module 1800 may include a communication unit 1810, a display 1820, a camera 1830, an artificial intelligence processor 1850, a speaker 1840, a sensing unit 1860, a memory 1880 with storage unit(s) 1882, and a processor 1870, and a system client 1865 which may be implemented as either a software application and/or hardware component and may be executable by processor 1870 and/or AI processor 1850 to facilitate operation of the module of the devices. The module 1800 may include a data bus 1890.

The communication unit 1810 may transmit and receive data to and from external devices such as other AI devices and an AI server by using wire/wireless communication technology. For example, the communication unit 1810 may transmit and receive sensor information, user input, a learning model, and a control signal to and from external devices.

The communications technology used by the communication unit 1810 may include GSM (Global System for Mobile Communication), CMDA (Code Division Multi-Access), LET (Long Term Evolution), 5G (5th Generation), WLAN (Wireless LAN), Wi-Fi (Wireless Fidelity), Bluetooth, RFID (Radio Frequency Identification), Infrared Data Association (IrDA), NFC (Near Field Communication), satellite communication, fiber optic communication, and the like.

The input unit 1820 may acquire various kinds of data including internal, external, user, persons other than the user, over wireless, etc. The input unit 1820 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information. In some examples, the input may include any other type of suitable input such as infrared/thermal, proximity, optical, laser, ultrasonic, radar, etc. The input unit 1820 may acquire learning data for model learning and input data to be used when an output is acquired by using the learning model. The input unit 1820 may acquire raw input data. In some examples, the processor 1880 or the AI processor 1830 may preprocess input data. The AI processor 1830 may learn a model composed of an artificial neural network (ANN) by using learning data. The learned ANN may be referred to as a learning model. The learning model may be used to infer result value for new input data rather than learning data, and the inferred value may be used as a basis for determining optimization information (e.g., intensity coefficients) whether to perform certain operation(s).

The AI processor 1850 may perform AI processing together with the learning processor 1870 of the AI server 1800. In some embodiments, the learning processor 1870 may include a memory integrated or implemented in the device 1800. Alternatively, the AI processor 1850 may be implemented by using the memory 1880, an external memory directly connected to the device 1800, or a memory held in an external device.

The sensing unit 1860 may acquire at least one of internal information about the device 1800, ambient environment information about the device 1800, and user information by using various sensors. Examples of the sensors included in the sensing unit 1860 may include a proximity sensor, occupancy sensor, an illuminance sensor, an acceleration sensor, a magnetic sensor, a gyro sensor, an inertial sensor, RBG sensor, IR sensor, a fingerprint recognition sensor, ultrasonic sensor, optical sensor, microphone, lidar, a radar, etc.

The output unit 1820 may generate an output related to a visual sense, an auditory sense, or a haptic sense. The output unit 1820 may include a display unit for outputting time information, a speaker 1840 for outputting auditory information, and a haptic module for outputting haptic information.

The memory 1880 may store data that supports various functions of the device 1800. For example, the memory 1880 may store input data acquired by the input unit 1810, learning data, a learning model, a learning history, and the like.

The processor 1870 may determine at least one executable operation of the device 1800 based on information determined or generated by using a data analysis algorithm or a machine learning algorithm. The processor 1870 may control the components of the device 1800 to execute the determined operation. The processor 1870 may request, search, receive, or utilize data of the learning AI processor 1850 or the memory 1880. The processor 1870 may control the components of the device 1800 to execute the predicted operation or the operation determined to be desirable among the at least one executable operation.

The processor 1870 may collect history information including the operation contents of the device 1800 or the user's feedback on the operation and may store the collected history information in the memory 1878 or the AI processor 1850 or transmit the collected history information to the external device such as a server. The collected history information may be used to update the learning model. In some embodiments, the collect history information of many users may be aggregated to update the learning model.

The processor 1870 may control at least part of the components of the device 1800 so as to drive an application program stored in memory 1880. Furthermore, the processor 1870 may operate two or more of the components included in the device 1800 in combination so as to drive the application program.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. Those skilled in the art will recognize how best to implement the described functionality presented throughout this disclosure depending on the particular application and the overall design constraints imposed on the overall system.

What is claimed is:

1. A spectrally tunable lighting system comprising:
a plurality of spectrally tunable light elements, each of the plurality of light elements having a spectral response curve defined by an intensity coefficient and frequency response;
a memory for storing pre-computed intensity coefficients for each of the plurality of spectrally tunable light elements, wherein the pre-computed intensity coefficients are determined prior to a runtime of the spectrally tunable lighting system, and wherein the pre-computed intensity coefficients correspond to vertices of a simplex mesh of the spectral response curve;
wherein the memory further stores instructions for controlling the spectrally tunable lighting system based on the stored pre-computed intensity coefficients; and
a processor configured for executing the instructions of the memory.

2. The spectrally tunable lighting system of claim 1, wherein the pre-computed intensity coefficients are determined based on one of: barycentric coordinate computation, solving a linear combination of target simplex points, ratios of sub-simplex volumes or areas, matrix inversion calculation, or iterative numerical calculation based on the target vertices of the simplex mesh.

3. The lighting system of claim 1, wherein the plurality of spectrally tunable light elements comprises at least two spectrally tunable light elements, wherein the at least two spectrally tunable light elements each has a different frequency response from another of the plurality of spectrally tunable light elements.

4. The lighting system of claim 1, wherein the vertices of the simplex mesh correspond to at least one of a visual or non-visual optimization metric.

5. The lighting system of claim 1, wherein the pre-computed intensity coefficients are computed at an off-device processor.

6. The lighting system of claim 1, further comprising:
at least one sensor configured for receiving environmental feedback data,
wherein the memory further stores instructions for determining a new set of intensity coefficients based on the received environmental feedback data.

7. The lighting system of claim 6, wherein the at least one sensor is one of: a thermal sensor for receiving and compensating temperature-dependent variations in spectral output; an ambient light sensor configured for measuring environmental luminosity; an occupancy sensor configured for controlling an on-off state of the lighting system; a color sensor configured for measuring an actual spectral output to control a closed-loop feedback control system.

8. The lighting system of claim 6, wherein the at least one sensor is configured for controlling one of an input stage or output stage of target vertices of the simplex mesh.

9. The lighting system of claim 1, wherein the pre-computed intensity coefficients are determined based on a neural network comprising a plurality of parameters, the neural network being trained based on at least one set of data received from a plurality of deployed lighting systems or notional lighting systems, wherein the data comprises a set of environmental feedback data and the vertices of the simplex mesh.

10. The lighting system of claim 9, wherein the training data comprises at least one of factory specification data, notional deployment systems, or received data from the deployed lighting systems.

11. A method for a spectrally tunable lighting system, the method comprising:
retrieving, at a memory of the spectrally tunable lighting system, a plurality of pre-computed intensity coefficients for a plurality of spectrally tunable light elements of the lighting system, each of the plurality of light elements having a spectral response curve defined by an intensity coefficient and frequency response, and the pre-computed intensity coefficients determined prior to a runtime of the lighting system, wherein the pre-computed intensity coefficients correspond to vertices of a simplex mesh of the spectral response curve;
powering the plurality of light elements based on the pre-computed intensity coefficients.

12. The method of claim 11, wherein the pre-computed intensity coefficients are determined based on one of: barycentric coordinate computation, solving a linear combination of target simplex points, ratios of sub-simplex volumes or areas, matrix inversion calculation, or iterative numerical calculation based on the target vertices of the simplex mesh.

13. The method of claim 11, wherein the plurality of spectrally tunable light elements comprises at least two spectrally tunable light elements, wherein the at least two spectrally tunable light elements each has a different frequency response from another of the plurality of spectrally tunable light elements.

14. The method of claim 11, further comprising:
determining, at an off-device processor to the spectrally tunable lighting system, the pre-computed intensity coefficients.

15. The method of claim 11, wherein the lighting system further comprises at least one sensor configured for receiving environmental feedback data, the method further comprising:
determining a new set of intensity coefficients based on the received environmental feedback data.

16. The method of claim 15, wherein the at least one sensor is one of: a thermal sensor for receiving and compensating temperature-dependent variations in spectral output; an ambient light sensor configured for measuring environmental luminosity; an occupancy sensor configured for controlling an on-off state of the lighting system; a color sensor configured for measuring an actual spectral output to control a closed-loop feedback control system.

17. The method of claim 16, further comprising:
controlling one of an input stage or output stage of target vertices of the simplex mesh based on the received environmental feedback data.

18. The method of claim 11, further comprising:
receiving a set of data comprising intensity coefficients and environmental feedback data; and
training a neural network model for optimization of the intensity coefficients based on the received set of data.
